(19) United States
(12) Patent Application Publication
(10) Pub. No.: US 2026/0166549 A1
(43) Pub. Date: Jun. 18, 2026

(54) SYSTEM AND METHOD FOR SEMICONDUCTOR-BASED ISOLATION OF EXTRACELLULAR VESICLES

(71) Applicant: Bryan Joseph Rice, San Diego, CA (US)

(72) Inventor: Bryan Joseph Rice, San Diego, CA (US)

(21) Appl. No.: 19/383,553

(22) Filed: Nov. 7, 2025

Related U.S. Application Data
(60) Provisional application No. 63/718,523, filed on Nov. 8, 2024.

(51) Int. Cl. B01L 3/00; B01L 7/00; G01N 35/10

(52) U.S. Cl. CPC B01L 3/502761; B01L 7/00; G01N 35/1016; B01L 2200/04; B01L 2200/0652; B01L 2300/18; B01L 2400/0655; G01N 2035/103

(57) ABSTRACT

The present invention pertains to a system and method for a medical research instrument device consisting of instrument equipment and computer controls. The instrument equipment consists of electronic boards that are used to control and monitor the various actuators and sensors within the instrument. Software is executed on the computer to drive the human interface and control assay methods. The present invention uses dielectrophoresis (“DEP”) to preferentially collect specific particles from a biological sample. The type of particles collected are driven by the parameters used to define the electric field used in DEP. The device passes the samples and various reagents across a patterned silicon die capable of creating the electric fields used within the DEP process.

### CROSS REFERENCE TO RELATED APPLICATIONS

This application claims the benefit of U.S. Provisional Patent Application No. 63/718,523, filed Nov. 8, 2024, the contents of which are incorporated herein by reference.

### BACKGROUND OF THE INVENTION

The present invention is directed to a system and method for a research instrument device that automates isolation of extracellular vesicles from biological fluids or matrices. Extracellular vesicles (“EVs”) are nano-sized, membrane-bound particles released by cells throughout the body that play a key role in intercellular communication. EVs are present in biological fluids including blood, urine, cerebrospinal fluid, etc.

Dielectrophoresis (“DEP”) can be employed to capture EVs from fluids or biological matrices. DEP works by exerting a force on a dielectric particle when it is subjected to a non-uniform electric field. DEP does not require that the particle be a charged particle, as all particles exhibit dielectrophoretic activity in the presence of electric fields. The present invention takes advantage of the particle-capturing abilities of DEP in the collection of EVs.

### SUMMARY OF THE INVENTION

The present invention pertains to a system and method for a research instrument device consisting of instrument equipment and computer controls. The instrument equipment consists of electronic boards that are used to control and monitor the various actuators and sensors within the instrument. Software is executed on the computer to drive the human interface and control assay methods. The software is separated into two parts: the graphical user interface (“GUI”) and the application programming interface (“API”) server. In concert with firmware and the GUI, the electrical system completes the entire cycle of loading, prepping, and processing a sample with minimal user interaction. The GUI makes REST calls to the API server which then sends ExoComm commands via USB to the instrument.

The present invention uses dielectrophoresis (“DEP”) to preferentially collect specific particles from a fluid sample. The type of particles collected are driven by the parameters used to define the electric field used in DEP. The device passes the samples and various reagents across a patterned silicon die capable of creating the electric fields used within the DEP process. The die is mounted in a processing chamber that controls the fluid volume exposed to the DEP and performs micro-mixing. During this process, the device also performs function-specific measurements used in various feedback and control loops in the SW to tune the collection to the desired particle.

An electric field capable of performing DEP is created using a signal generation IC. The resulting waveform is passed through a gain and shaping analog chain before being amplified into a high-power signal applied to the chip. Inline metrology is performed at generation load time to ensure the correct frequency components and voltage amplitude are present as required by the DEP parameters.

Fluidic control is handled by a robotic pipette handler capable of selecting, delivering, and moving fractional microliters of the sample/reagents stored on a disposable process cartridge. Various valves and pumps are controlled from FW to allow precise volume and flowrate desired to be present in the process chamber while the DEP is active. Waste fluids are removed and disposed of in a safe and automated manner. The hardware component of the instrument is designed to allow reconfiguration of frequency and voltage to each of the various fluid ICs present in the system.

Process thermal control uses Peltier thermoelectric coolers (“TEC”) and thermocouple (“TC”) sensors to precisely control the local temperature in the processing chamber. Temperature control is used to enhance collection and protect the biological sample from temperature-based degradation during the process. Inline metrology collects continuous and on-demand readings from each relevant process parameter to allow for active process control.

The electrical portion of the device is divided into functional areas: communication and control of the instrument is performed by multiple microcontrollers running the firmware described herein. Fluidic manipulation is performed via a set of motors, pumps, resistance and mechanically driven valves controlled by optical and/or mechanical sensors. Sample processing is performed within the fluidic integrated circuit (“IC”) by application of voltage and frequency defined electrical signals developed to perform DEP according to process parameters. For sample recovery quality and performance, the following components are controlled and monitored by the firmware: pressure sensors, temperature sensors, voltage sensors, cooling fans, and TEC. Power generation and applicable safety interlocks are handled with electronic and mechanical controls. The microprocessor interfaces with the peripherals via a combination of SPI, I2C, direct GPIO, and UART. Various hardware components are used for voltage and protocol translations. Power is supplied to the system via a 24V external “brick style” power supply and further processed inside the system to the voltages required to support all the mechanical and signal driven dissipation. The power system is also filtered at inputs and outputs to mitigate EMI in either direction.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 shows the mechanical architecture of the present invention.

FIG. 2 shows the electronics architecture of the present invention.

FIGS. 3A-C show the software and firmware architecture of the present invention.

FIGS. 4A-G show various pages of the graphical user interface associated with the present invention.

FIGS. 5A-C show the assembly components of the present invention.

FIGS. 6A-H show the assembly components of the pipette gantry head.

FIGS. 7A-C show the assembly components of the pogo pin lifter.

FIGS. 8A-C show the assembly components of the Peltier lifter.

FIGS. 9A-F show the assembly components of the pinch valve lifter.

FIGS. 10A-D show the assembly components of the cartridge receiver.

FIG. 11 shows the assembly components of the back plate.

FIGS. 12A-D show the outer assembly components and air vent flow.

### DETAILED DESCRIPTION OF THE PREFERRED EMBODIMENT

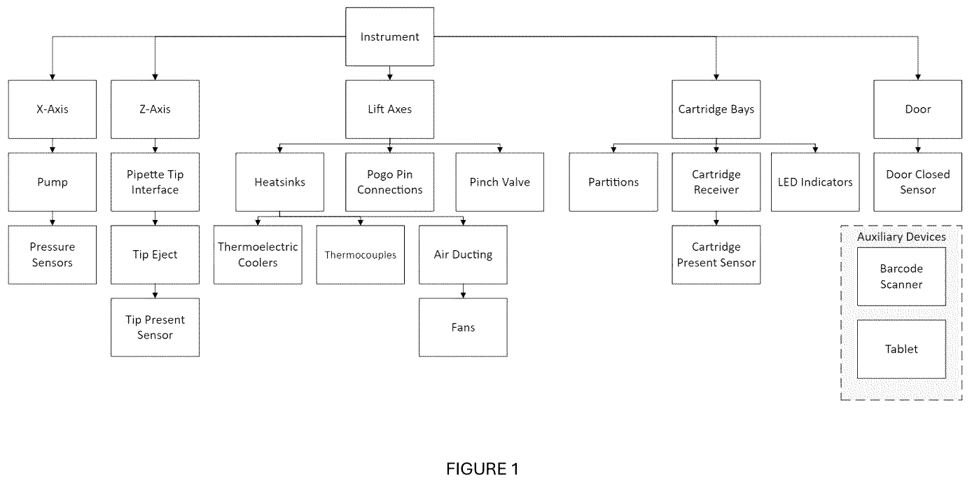

FIG. 1 shows the mechanical architecture of the present invention. In accordance with the preferred embodiment of the present invention, the instrument comprises a plurality of systems including an x-axis, z-axis, lift axes, cartridge bays, and door system. The x-axis system may comprise subsystems including pump and a pressure sensor subsystem. The z-axis system may comprise a pipette tip interface, a tip eject, and a tip present sensor subsystem. The lift aces system may comprise heatsinks, pogo pin connections, and a pinch valve subsystem. The heatsinks may comprise thermoelectric coolers, thermocouples, and air ducting fans. The cartridge bays may comprise partitions, cartridge receivers, and LED indicators. The cartridge receiver may further comprise cartridge present sensors. The door system may comprise a door closed sensor and other features that are contemplated herein. The mechanical architecture may further comprise auxiliary devices including a barcode scanner and a tablet which may be a computing device configured with a touch screen or other interactive interfaces.

The firmware uses a system to represent all the addressable peripherals and components (virtual and physical) within the instrument to allow uniform reference to any entity and address it from other parts of the software. The Firmware Entity System also defines an addendum to the ExoComm Protocol that allows the computer interfacing with the firmware to sue the same entity system to control and monitor peripherals in a generic way without having to modify and upgrade the firmware source code. The entity system also allows the firmware to store a set of smaller instructions or microcode and ability to load into persist storage at run-time other instructions that can be executed for expanded features.

The firmware is used to generate timing for the various stepper motors to ensure fixed speed (RPM, mm/min). The firmware has the ability to translate the pump flowrate requirements into stepping frequency that is then used to drive the motor attached to the pump. The motor controlling mechanism is implemented using the firmware's application framework's timer and real-time event system. The motor control timing algorithm is as follows:
Message handling: motor movement is requested at a specified speed (μsec/pulse), micro stepping, number of steps. The firmware processes and records the information and sends one-time setup parameters to the various peripherals (e.g. driver chip). The firmware also sets up the real-time task expiry time for each motor based on the speed. The firmware creates step counters for the motor(s) in question and set their state to running as part of the Real-Time events handling. Main thread is running, all high priority IRQ and messages have been processed. Main thread checks if any motor needs to be serviced by comparing current time against expiry deadline. If expired, the motor is serviced by stepping. If not, move on to other motors. When all motors are serviced and steps remain, stay awake. When all motor movements are finished, the processor is allowed to sleep. This algorithm keeps the motor control in a tight loop to ensure that when motor movement is in action with no sleep time in the processor to reduce overhead. With the motor control algorithm, the motor performance can be controlled to a typical timing of 200 msec per stepper movement and as slow as possible with a stepper motor.

The firmware utilizes a PID controller that is used to provide Pulse-Width Modulation (PWM) of the TEC device to achieve constant temperature in the Fluid IC chip. The temperature control aims to keep the chip's temperature around 10 to 15 degrees Celsius to allow the biological material to be in optimal conditions for isolation and capture. This PID controller is implemented using the firmware's application framework's timer and real-time event system. The temperature control timing algorithm is as follows:
Message handling: a temperature set point is requested. The firmware processes and records the information and sends one-time setup parameters to the various peripherals (e.g. PWM control chip). The firmware also sets up the real-time task expiry time for each TEC based on the settings. The firmware sets up a recurring timer to send a message to process TEC controller. Main thread is running, all high priority IRQ and messages have been processed. Main thread checks message queue to see if a TEC process event was schedule. If scheduled, the TEC controller is serviced by running the current measured temp through a dedicated PID controller routine to obtain the new TEC setting. If not, move on to other TECs. Reschedule the message to be sent again at the same interval. When all TECs are serviced (or if there are no TECs to be serviced), the processor is allowed to sleep. This algorithm uses a timer that sends events through a message queue. Because the intervals between processing is large, the risk of messages overflowing the queue is low and the overhead is small compared to tight-looped control.

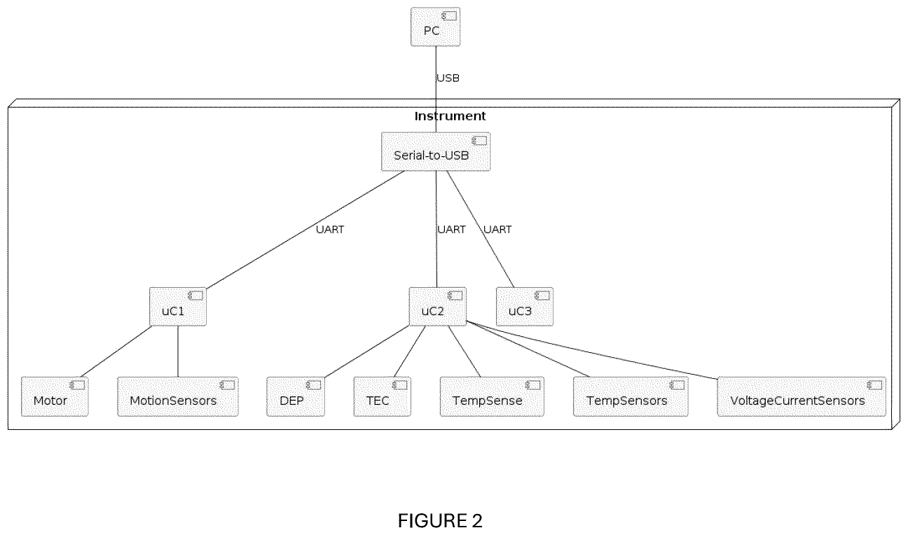

FIG. 2 shows the electronics architecture of the present invention. In accordance with the preferred embodiment of the present invention, a computer system, which may be a personal computer (“PC”) or other computing device, is connected to the present invention. The connection may be by way of universal serial bus (“USB”) or, in other embodiments, other wired connection methods or wireless connection methods may be employed including but not limited to Bluetooth, Wi-Fi, or other methods. In the preferred embodiment, a PC is connected to the instrument via USB. A serial-to-USB adapter connects a serial cable to a USB port. A plurality of universal asynchronous receiver/transmitters (“UARTs”) connect the PC to a plurality of solid-state logic hardware plug-in controllers (“UC1;” “UC2;” “UC3”). UC1 provides a communication pathway between the PC and at least one motor system and motion sensor system associated with the present invention. UC2 provides a communication pathway between the PC and the DEP system, TEC, Temp Sense, Temp Sensors, and Voltage Current Sensors.

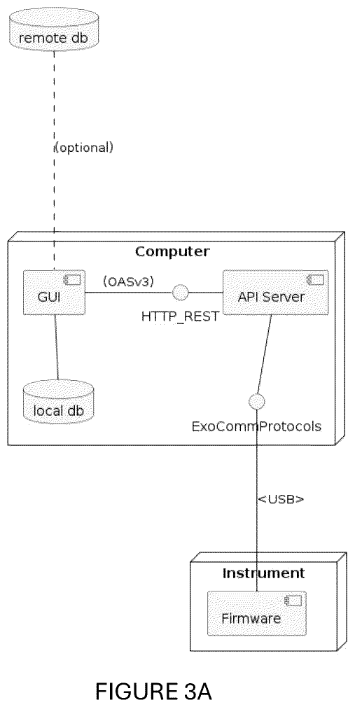

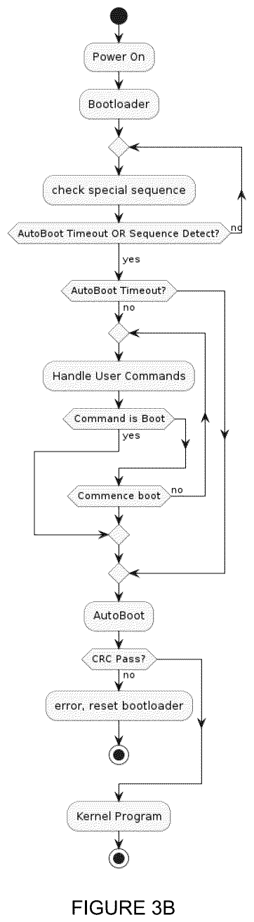

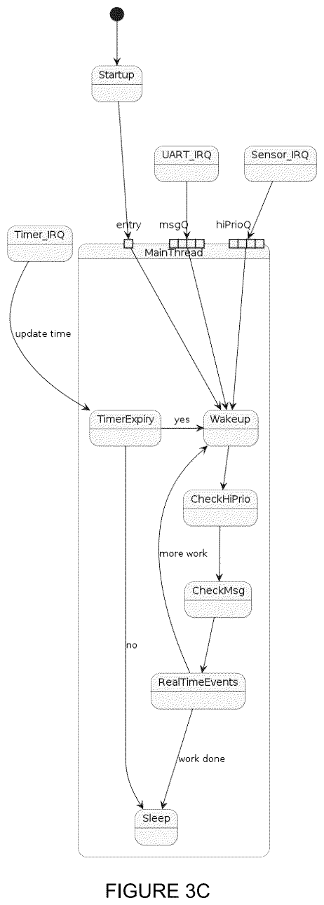

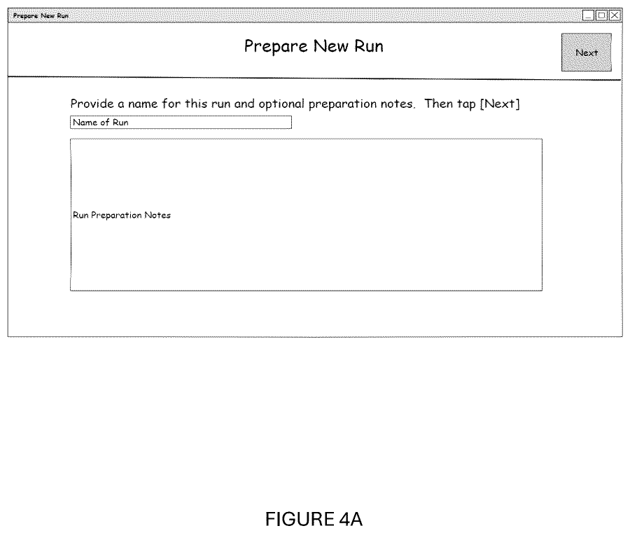

FIGS. 3A-C show the software and firmware architecture of the present invention. In accordance with the preferred embodiment of the present invention, the GUI is a user facing software application designed with a simple, wizard-based interface. The GUI allows users to choose a method which will drive the hardware interactions taken by the instrument. The GUI provides the user with the ability to manage and execute various methods that are used to perform an assay on a set of given biological samples. The methods are specified via text-based recipe files that use domain-specific language for the biological assay process. Methods define the sequence of actions the GUI needs to take to perform an automated assay method. The methods can be encrypted to protect its contents from being exposed and to prevent unintended modification.

The GUI may be developed in the Dart programming language using the Flutter graphical user interface toolkit to allow deployment to multiple platforms (Windows, iOS, Android, Linux, MacOS, etc.), with different resolutions, in a modern user interface paradigm. The GUI may save its data to a SQL database which can be stored locally or on a network share, the data may include run history, methods, users, projects, settings, and more. Logs are maintained on a rotating basis and faults which occur during method execution are logged and support tickets can be optionally emailed if desired by the user. Cartridge types are validated against chosen methods to ensure the user has inserted the correct cartridges. The functionality of the GUI can be extended by importing new, certified methods. The GUI provides features to import and export data to and from SQL via external files. The GUI can upgrade the firmware used on the instrument as needed. Support tickets which include a user description, logs, and system information can be saved or emailed to an associated support team via selection of the appropriate buttons. The GUI can launch remote desktop services (if applicable) to allow support teleconferencing. The GUI controls various computer sleep and standby power saving features to prevent the assay method runs from being interrupted by the operating system.

The API server is a backend REST engine that listens to REST requests via HTTP and WEbsocket. The commands are specified using industry standard OpenAPI Specification v3 (OASv2) format. The API server translates REST requests into low-level firmware protocol messages sent to the firmware. The separation of the GUI from the API server decouples the GUI from the functional instrument control. All communication between the API and the GUI is defined by a common/well-defined set of operations that are not hardware dependent and fully independent of the user interface. Decoupling in this way allows future upgrades to the instrument and/or the GUI interface styling/framework without a lot of rewrites. The API server is software developed using Python programming language and compiled and installed on Windows as a system service.

The instrument firmware is developed using Modern C++ (C++20) programming language with GNU's Compiler Collective (GCC) provided by the vendor. The firmware includes a few backported C++23 headers to assist in memory-safe data structures and algorithm usage. The firmware is composed of a single software code repository under source control to facilitate common subroutine/module/function sharing. The firmware provides a common application framework so that the multiple microprocessors will have uniform operations (such as handling of interrupts from user command or sensor inputs). The microprocessor firmware is separated into two isolated execution contexts: Bootloader Mode and Kernel Mode.

FIG. 3B shows the interaction between Firmware Bootloader and Kernel Mode and the basic flow of Bootloader operation. Bootloader Mode supports in-field upgrades and rapid manufacturing without the need to deploy full firmware images. A special software sequence is required to enter this mode to minimize accidental erasure of data. This mode also provides independence from vendor-specific algorithms and protocols and verifies that the kernel image is valid, and integrity is good before giving control to the kernel image.

FIG. 3C shows the Kernel Mode operation in high-level view. Kernel Mode contains the full functionality to control and monitor all sensors and actuators in the system and is mostly read-only access. Firmware handles inputs (interrupts, messages, etc.) and performs necessary action to service those events. Firmware also performs timekeeping and list of timed events to allow periodic events to happen in a timely manner. Firmware also performs some time-sensitive conditions in performance or real-time mode to ensure timing requirements are satisfied for the various peripherals.

The firmware also communicates with the computer via two different proprietary software protocols: ExoComm Device Protocol and ExoComm Bootloader Protocol. ExoComm device protocol is the main protocol that is used to control various instrument required actions and is used in Kernel mode. ExoComm Bootloader Protocol is used in Bootloader mode and is a simplified command structure and has no instrument features. ExoComm Bootloader Protocol is used for manufacturing and device setup and for in-field upgrade. The firmware upgrade is deployed to instrument as a single image bundle containing, for each microprocessor, both the kernel and the bootloader. The firmware upgrade package also contains mechanisms (such as CRC or signature) to allow computer software to validate the integrity and validity of the upgrade package. The firmware also provides timers and mechanisms to allow for real-time events to be executed (such as motor control or sensor monitoring).

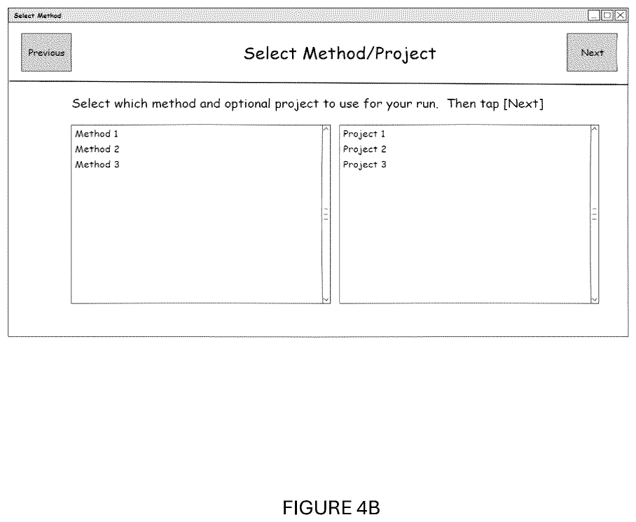

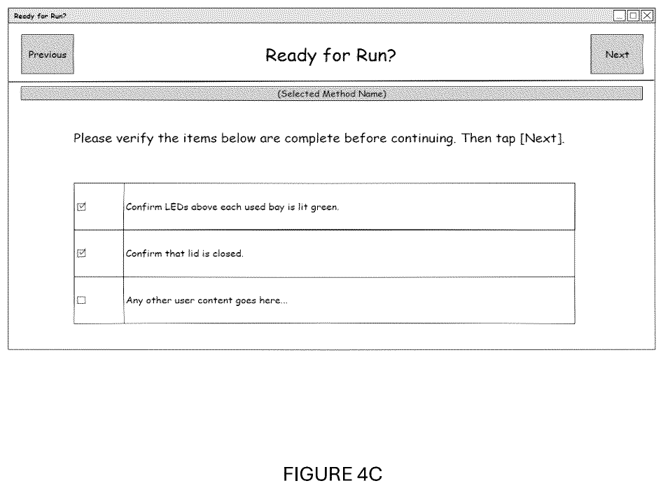

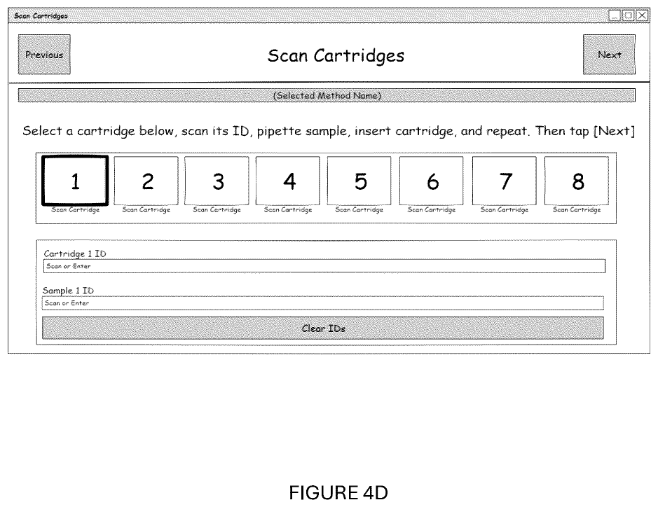

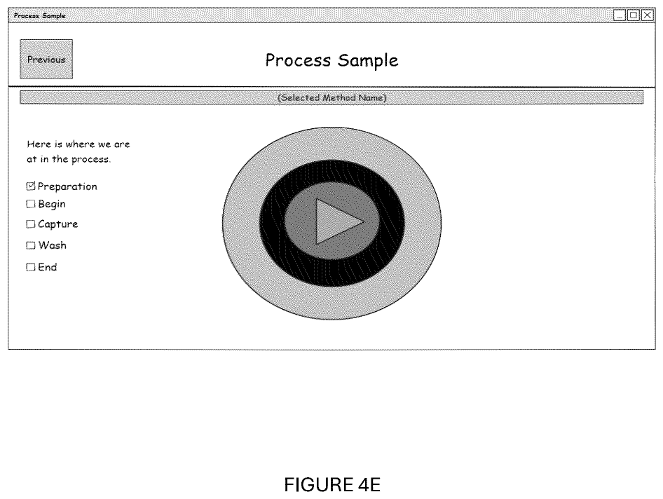

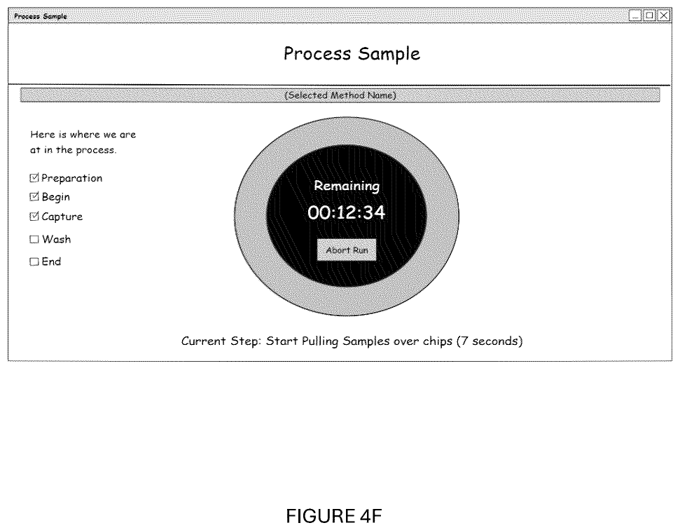

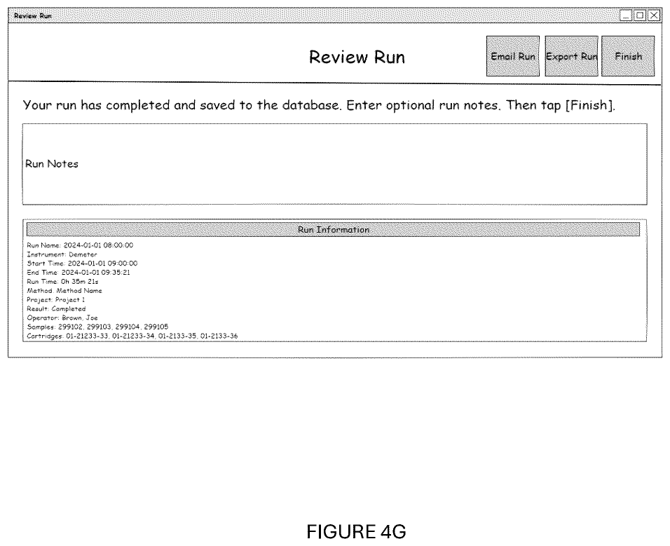

FIGS. 4A-G show various pages of the graphical user interface associated with the present invention. In accordance with the preferred embodiment of the present invention, the GUI may present several windows to a user throughout the course of use of the instrument. FIG. 4A shows an exemplary “prepare new run” window, where a user may optionally provide, via typing, speech-to-text, or other input methods, a name for the run and run preparation notes. To proceed to the next step, the user may click the “next” button on the screen via a computer mouse, a plurality of buttons, or a touchscreen interaction, or other selecting methods. FIG. 4B shows the “select method/project” window. This window allows a user to select the method and optionally select a project for the run. A user can navigate between the windows by selecting the “previous” button or the “next” button in the top left and right corners of the window.

FIG. 4C shows the confirmation screen, where a user is asked to verify that the items listed are complete before continuing. Items that must be verified include but are not limited to confirming LEDs above each used bay is lit green and confirming that the lid is closed. A user may confirm by checking a box next to each item in need of verification. FIG. 4D shows a window providing further instructions for a user. The user is instructed to select a cartridge from the numbered slots on the screen which correspond with the cartridge slots in the system. The user is then instructed to scan the cartridge ID, pipette sample, insert cartridge, and repeat for all cartridges.

FIG. 4E shows the “process sample” window. A user is presented with a play button which, when clicked, will begin the sample processing. A check list to the left of the play button shows the order of operations and the current status of the system. FIG. 4F shows the “process sample” screen after the play button has been clicked. A countdown of time remaining will appear to the user, with the option to “abort run” should the user wish to halt the processing. FIG. 4G shows the “review run” window, which is presented when the run is complete. A user may optionally input run notes which will be saved to the database along with the run data collected from the system. A user may export or email the run data or review the run information or finish the run by selecting “finish.”

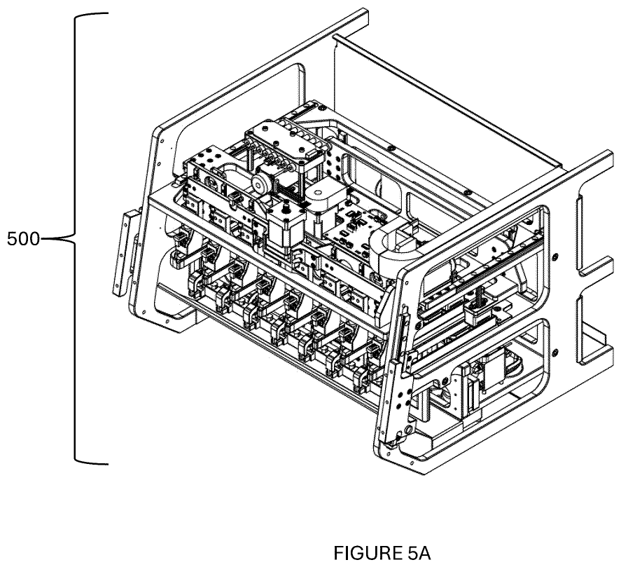

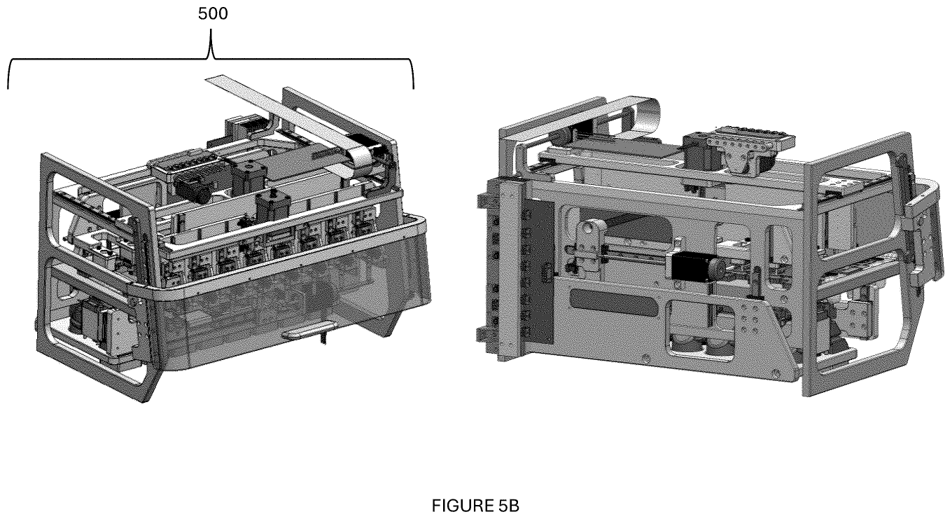

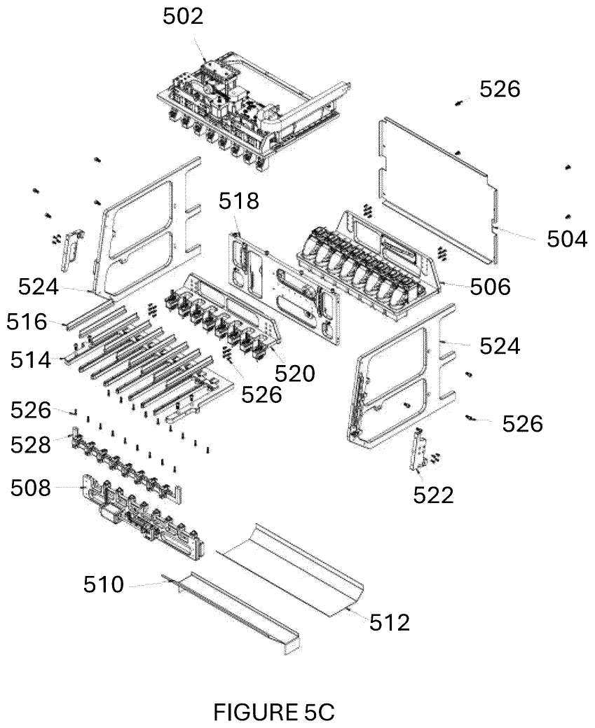

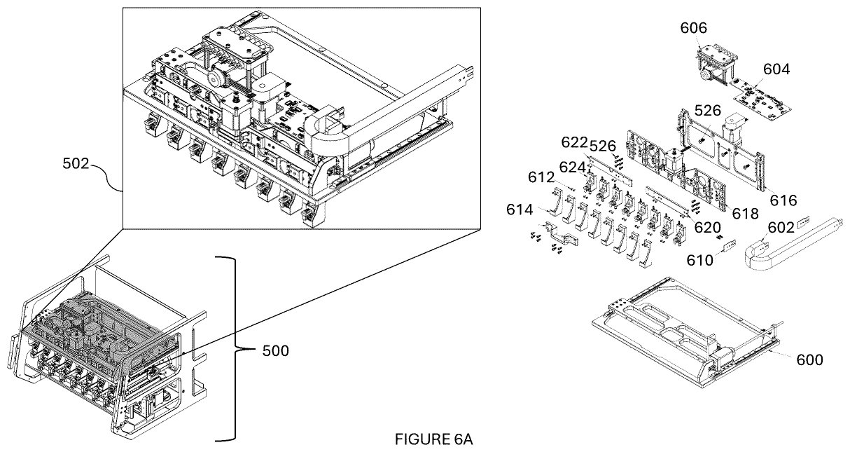

FIGS. 5A-C show the assembly components of the present invention. In accordance with the preferred embodiment of the present invention, the assembly components of the present invention comprise a pipette gantry head 502, a pogo pin lifter assembly 520, a Peltier lifter 506, a pinch valve lifter 508, a cartridge receiver 514, a back plate 518, and two side plates 524.

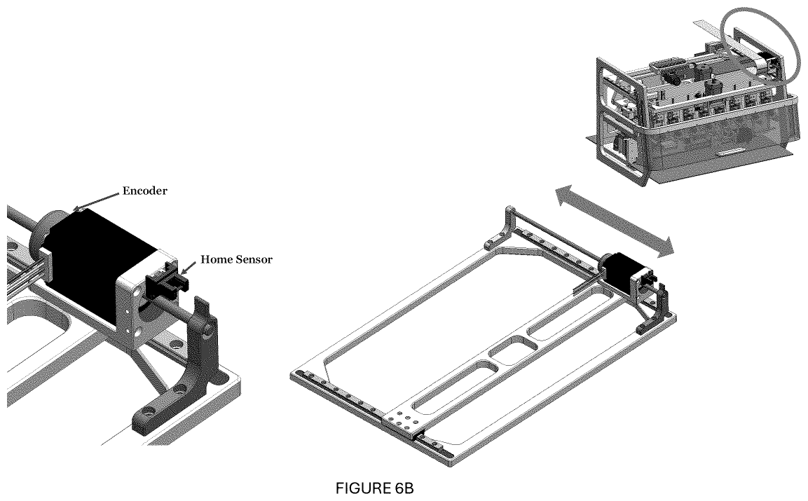

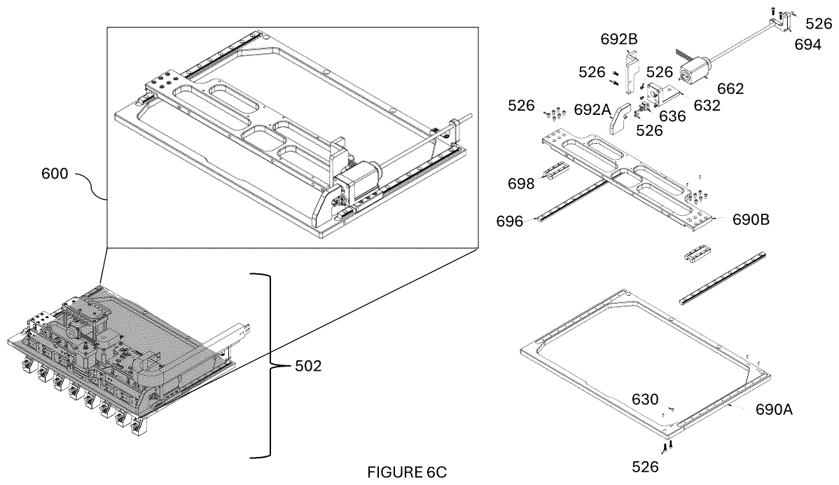

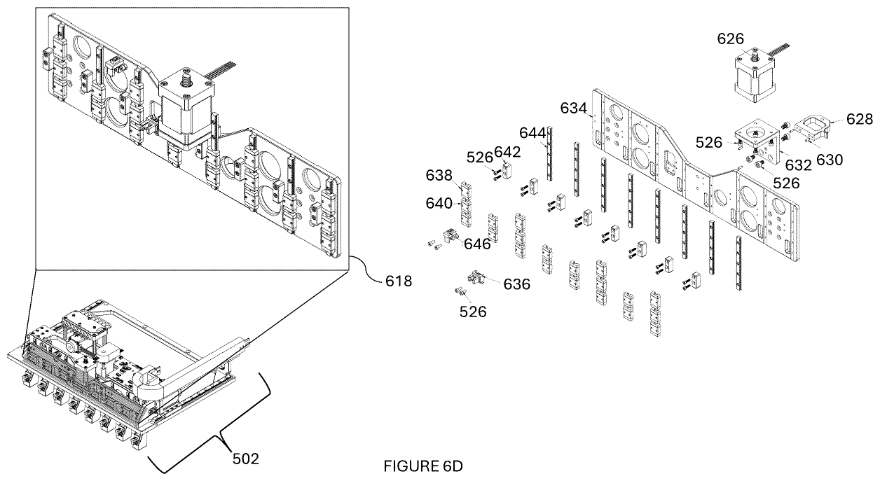

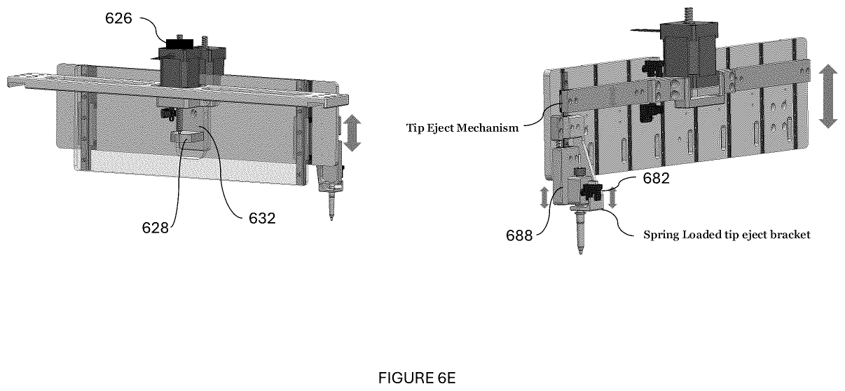

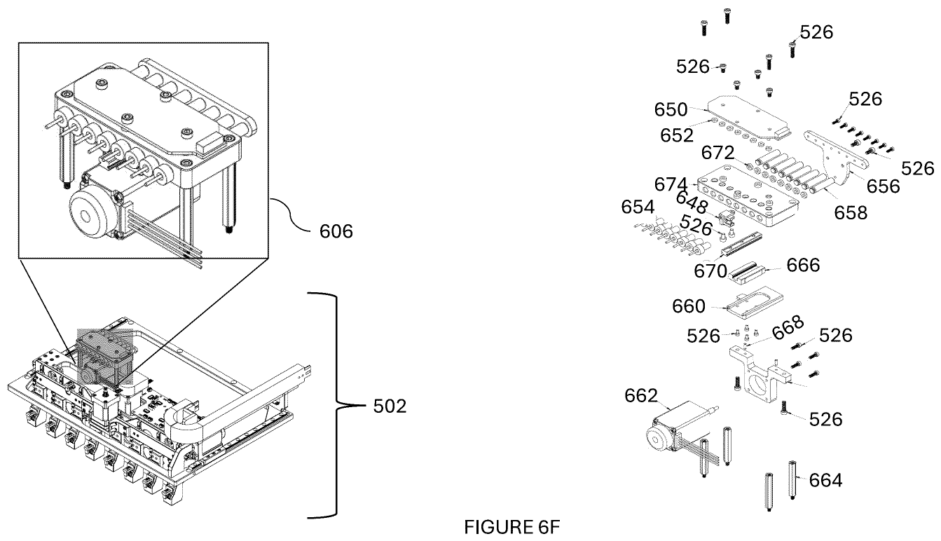

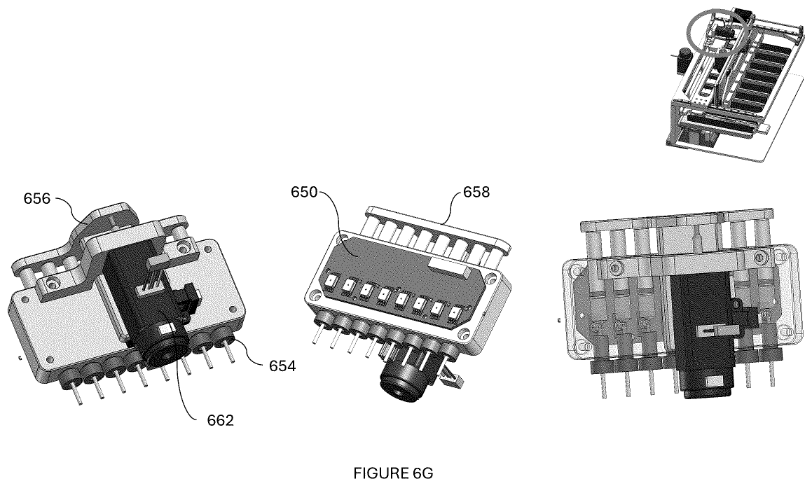

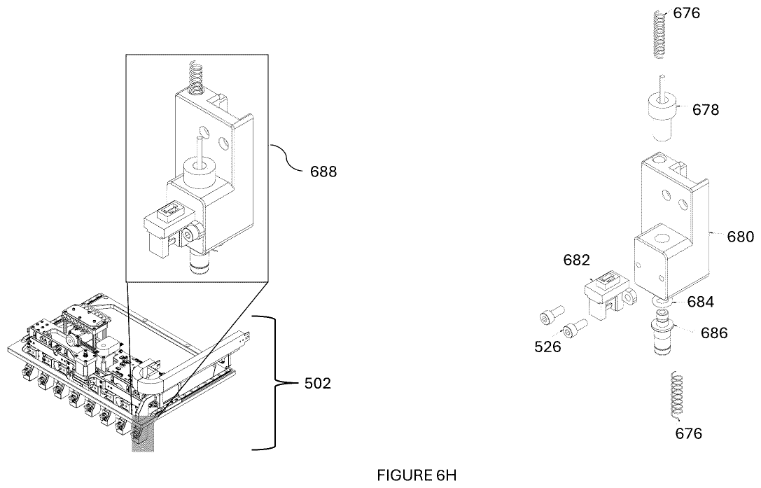

FIGS. 6A-H show the assembly components of the pipette gantry head. In accordance with the preferred embodiment of the present invention, the pipette gantry head 502 provides automated pipetting of the sample and the reagents. The pipette gantry head 502 comprises a frame 600 and a main cross member, a pipette tip carrier 618, an eight-channel pump 606, and a pipette tip holder 688. The frame 600 enables pipette movement in the x-axis. The pipette tip carrier 618 provides pipette movement in the z-axis. The eight-channel pump enables pneumatic fluid pumping via motor 662 and pistons 658. The pipette tip holder 688 provides a spring-loaded interface between the pump and the pipette tip and provides confirmation of the presence of a pipette tip via a tip present sensor 682.

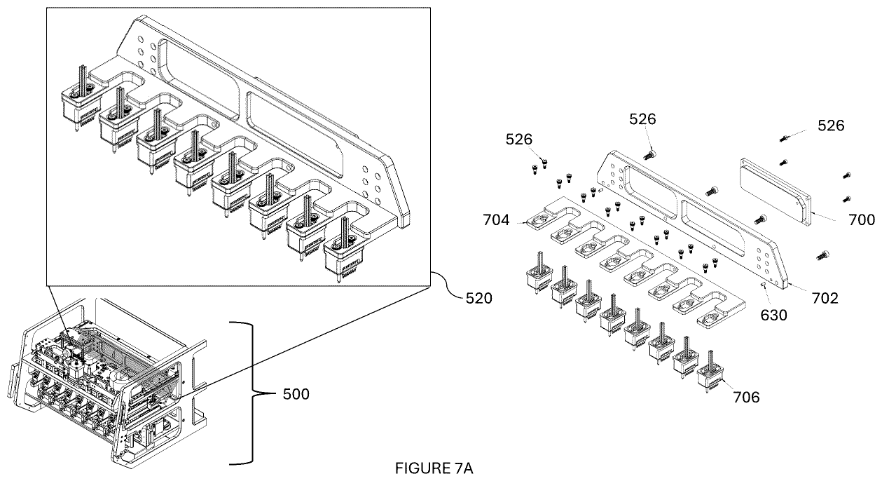

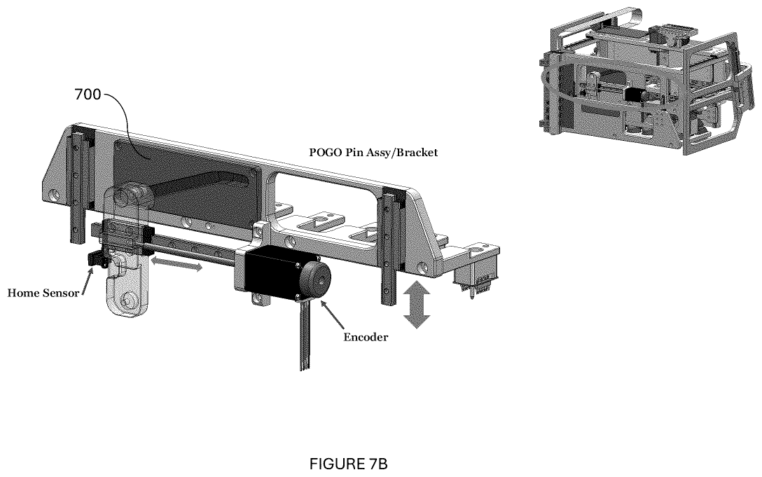

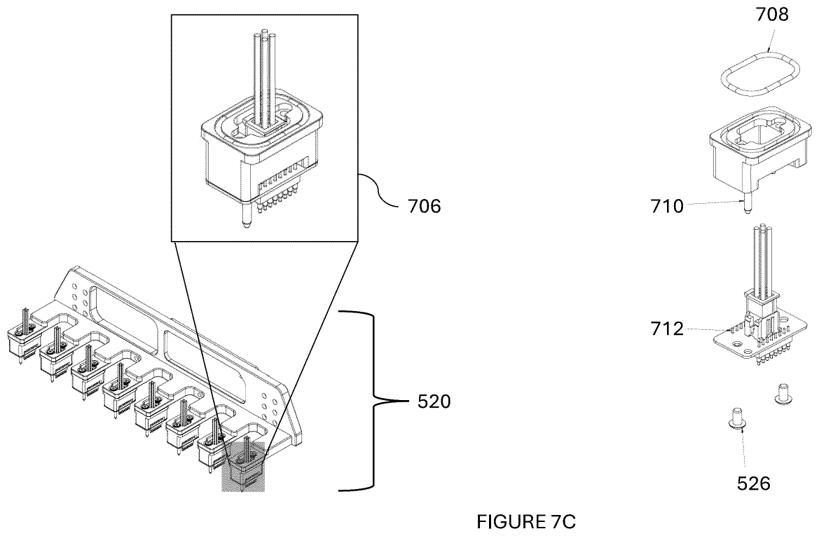

FIGS. 7A-C show the assembly components of the pogo pin lifter. In accordance with the preferred embodiment of the present invention, the pogo pin lifter assembly 520 carries pogo pin components for electrical interface to cartridge. The pogo pin lifter assembly 520 comprises a plurality of pogo pin blocks 706, which provide pogo pin interface to cartridge. The pogo pin lifter and Peltier lifter assembly may use linear cams for their actuation.

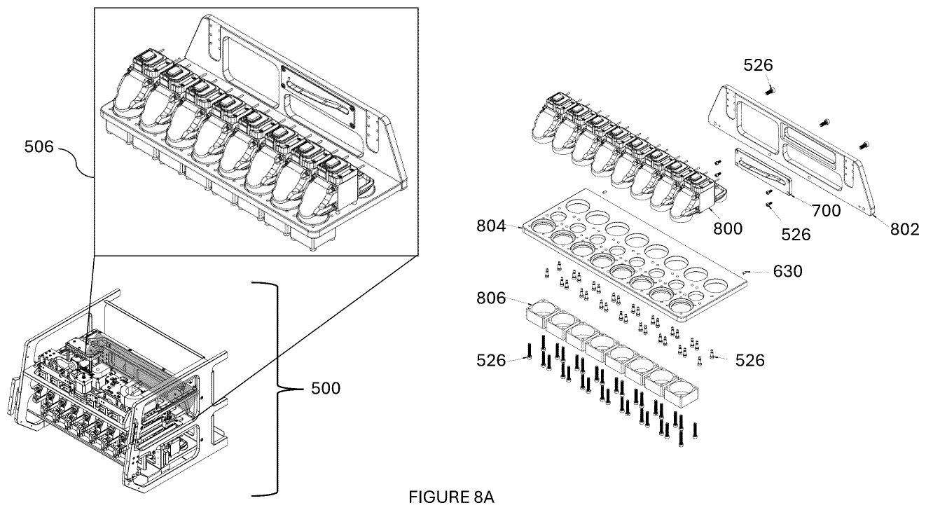

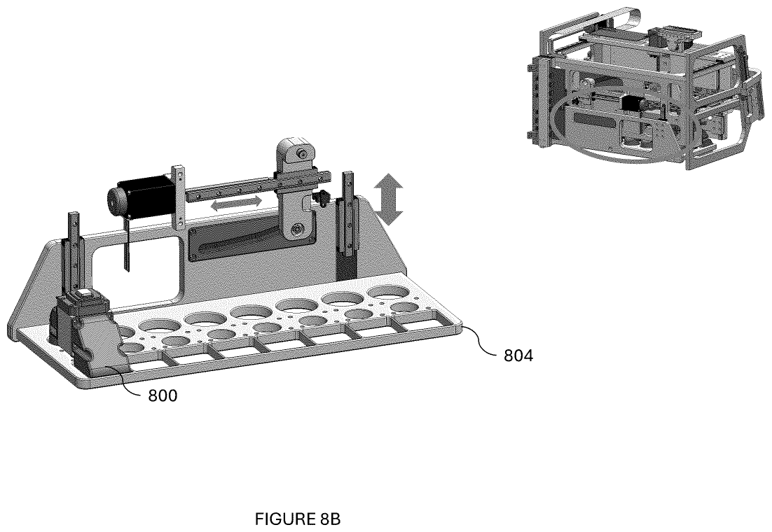

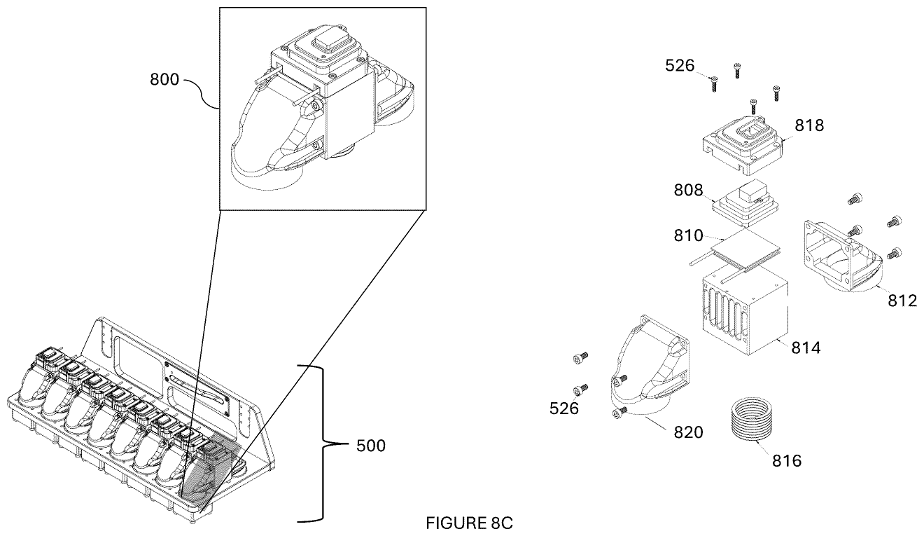

FIGS. 8A-C show the assembly components of the Peltier lifter. In accordance with the preferred embodiment of the present invention, the Peltier lifter 506 carries TECs, heatsinks, and ducting. The Peltier lifter 506 comprises a plurality of Peltier coolers 800. The Peltier coolers 800 are responsible for temperature control of the flow cell. When a cartridge containing a DEP chip is inserted into the system, the cartridge is placed in such a way that the backside of the DEP chip is in contact with the heat sink in order to control the temperature of the DEP chip environment. A pogo pin connector additionally drops down and makes electrical connection. Together, the heat sink, the pogo pin connector, and a semiconductor mechanism comprise the Peltier lifter. In some embodiments, the Peltier lifter is mobile. In some embodiments, the Peltier lifter is on an angled track.

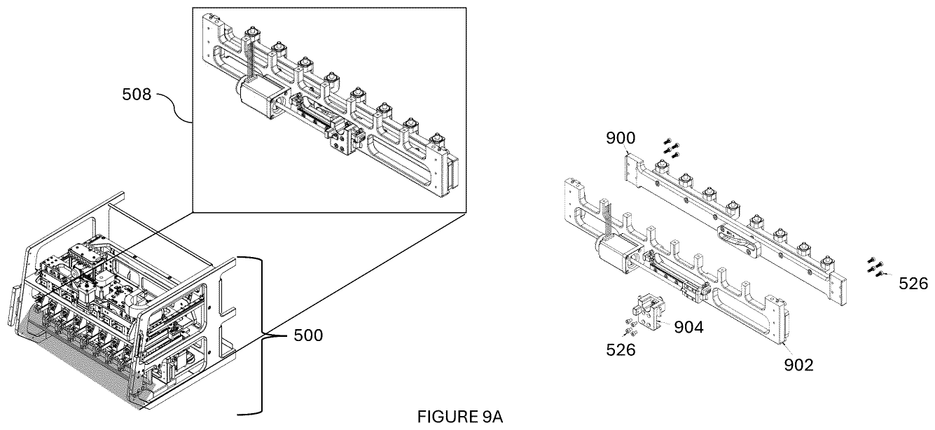

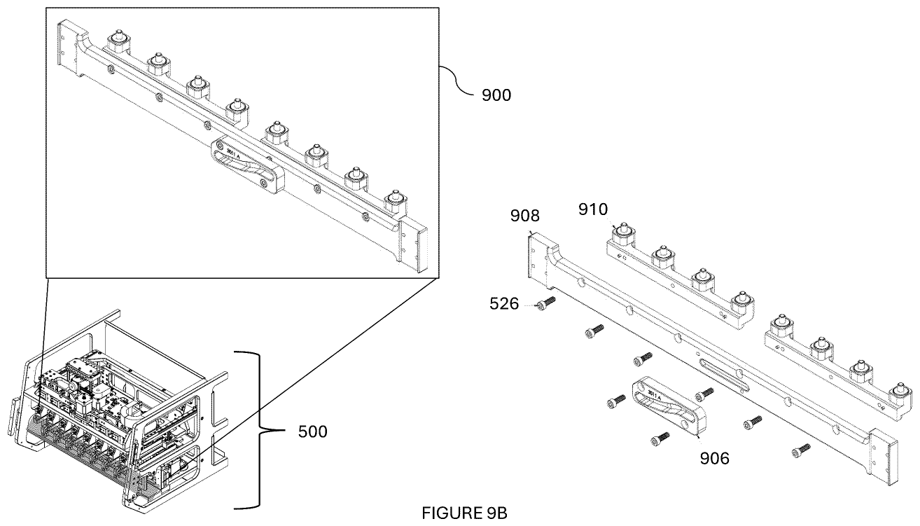

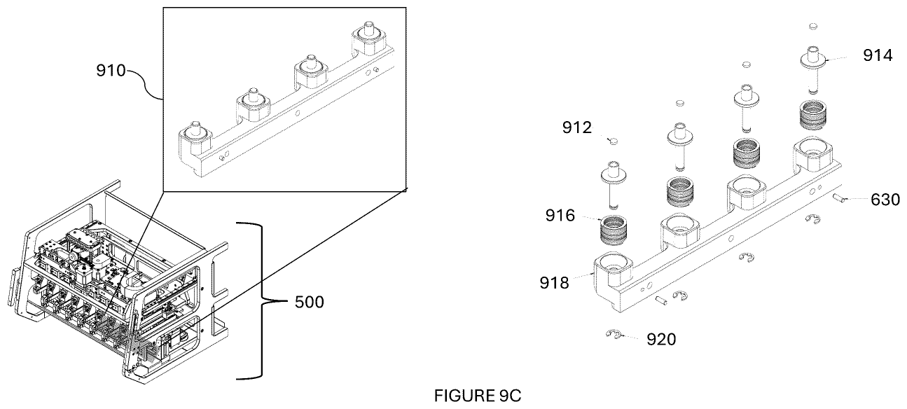

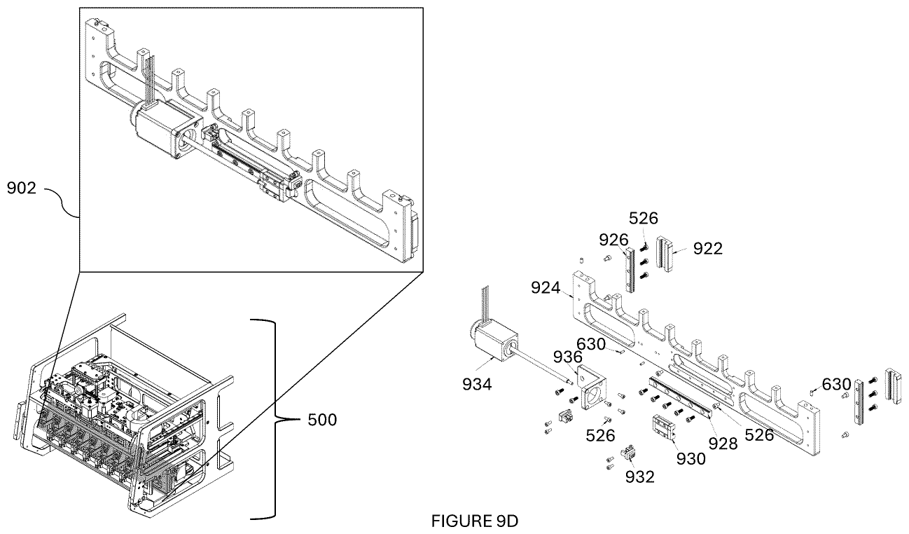

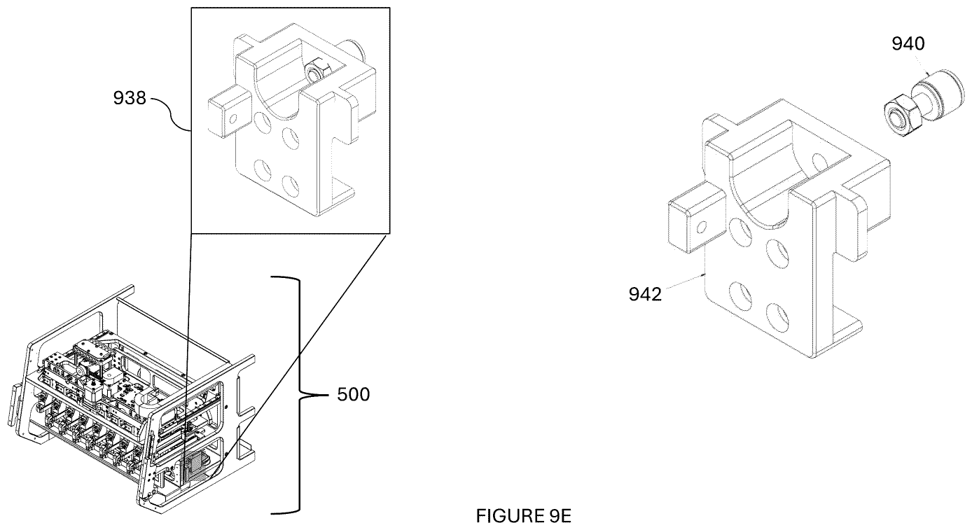

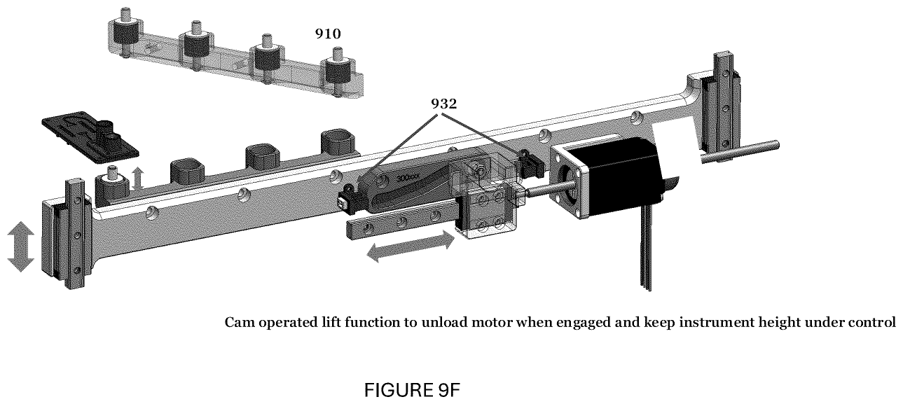

FIGS. 9A-F show the assembly components of the pinch valve lifter. In accordance with the preferred embodiment of the present invention, the pinch valve lifter 508 carries pinch valves and comprises a pinch valve pin cross member 900. The pinch valve pin cross member 900 is configured to enable cam movement of pinch valves under a cartridge. The pinch valve lifter 508 further comprises a pinch valve bracket 910. The pinch valve bracket 910 may comprise spring-loaded rubber pistons for sealing channels under a cartridge to selectively allow fluid flow. The pinch valve lifter 508 further comprises a fixed plate 902, and a cam follower 938.

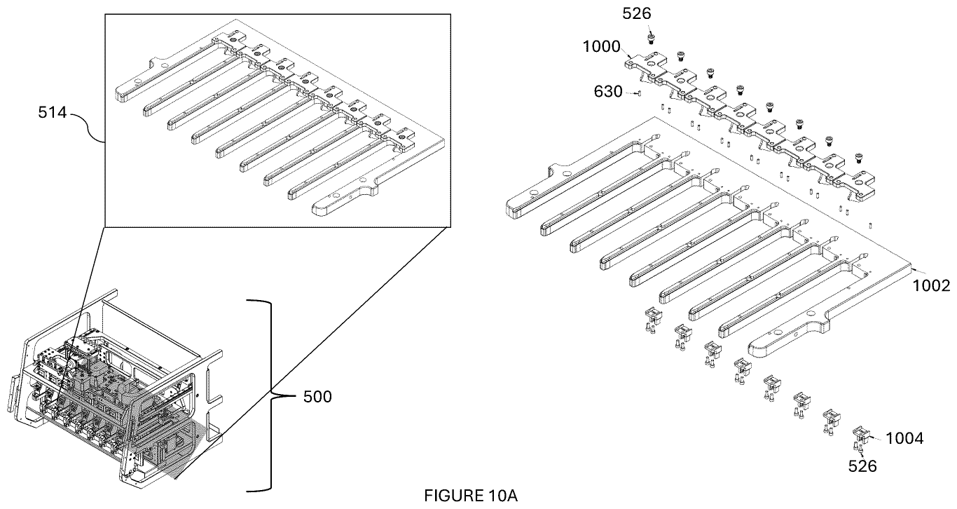

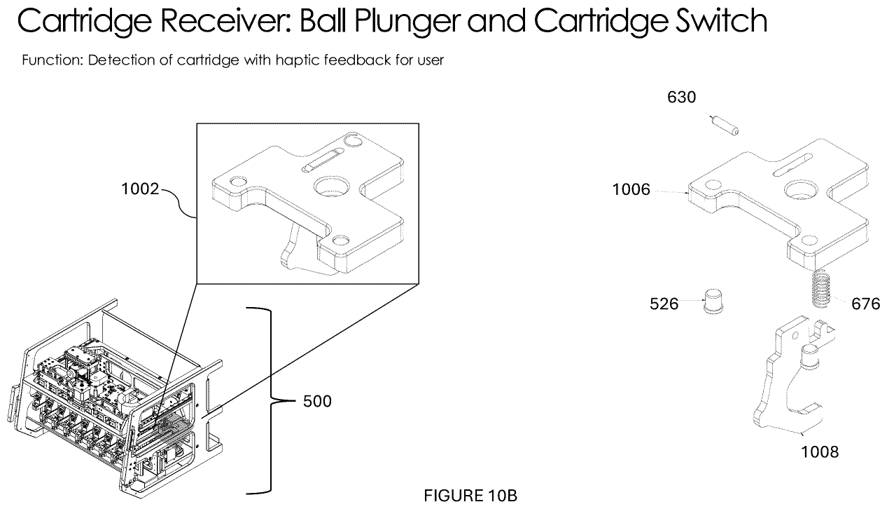

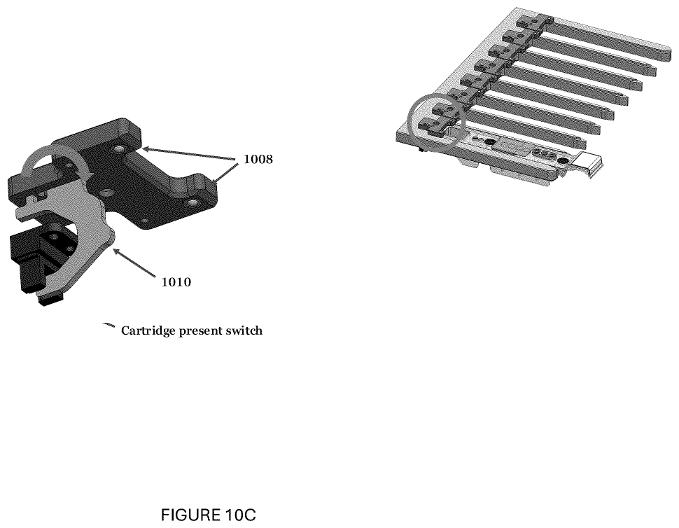

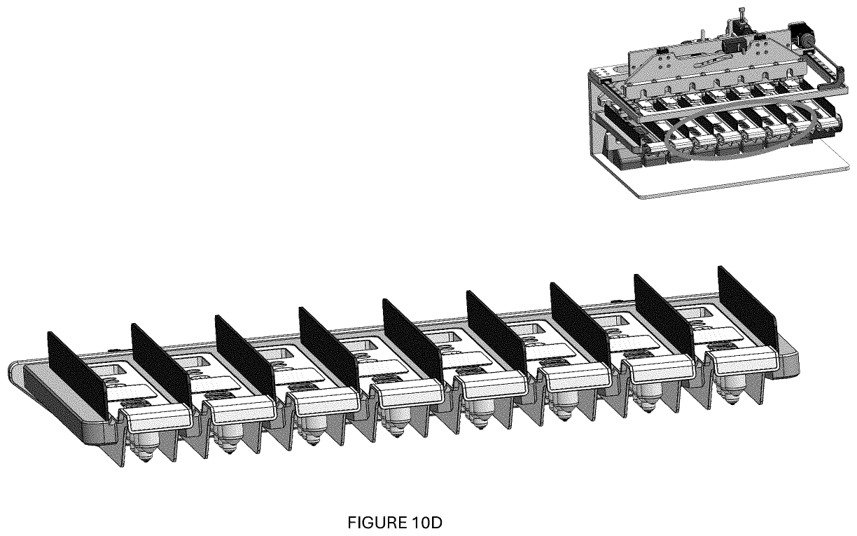

FIGS. 10A-D show the assembly components of the cartridge receiver. In accordance with the preferred embodiment of the present invention, the cartridge receiver 514 provides rails 1000 to slide a plurality of cartridges into the instrument. The cartridge receiver 514 further comprises a ball plunger and cartridge switch system 1002. The ball plunger and cartridge switch system 1002 enable detection of cartridge with haptic feedback for a user. The ball plunger 1006 detects whether or not a cartridge is in a correct position.

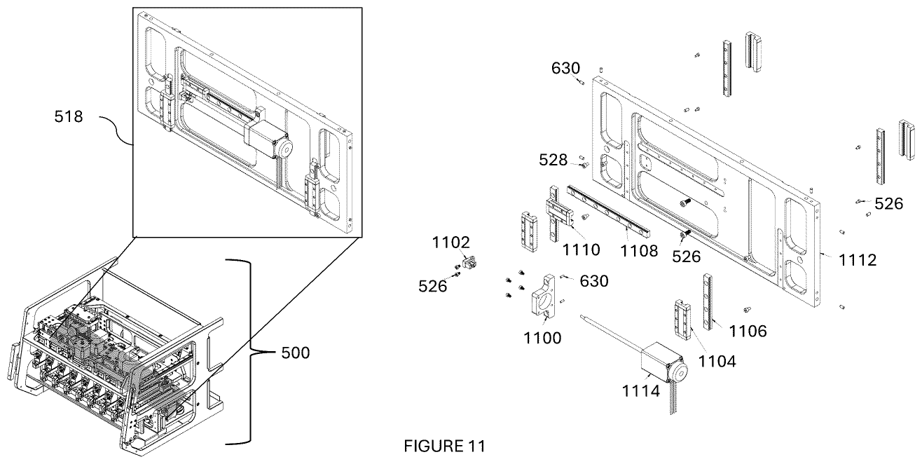

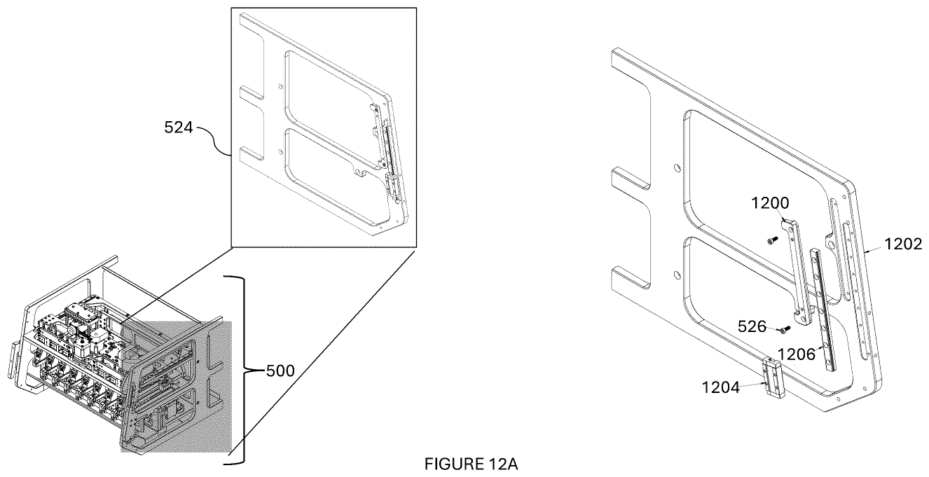

FIG. 11 shows the assembly components of the back plate. In accordance with the preferred embodiment of the present invention, the back plate or main plate 518 is a plate with a linear motor that drives both the Peltier lifter and pogo pin lifter. The Pogo pin lifter and Peltier lifters may use linear cams for their actuation. The motor shown in FIG. 11 may be the same motor as shown in FIGS. 7B and 8B.

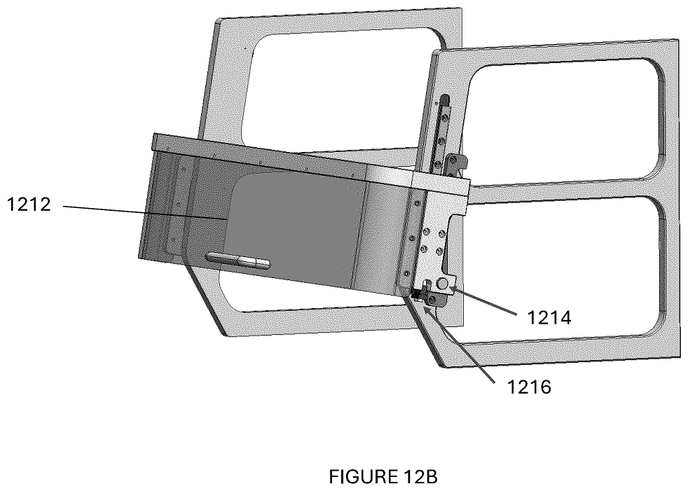

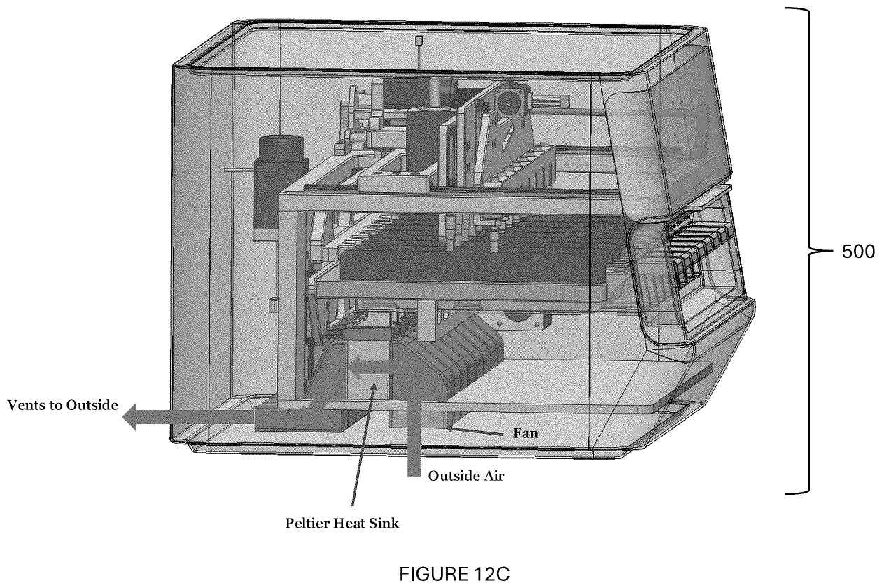

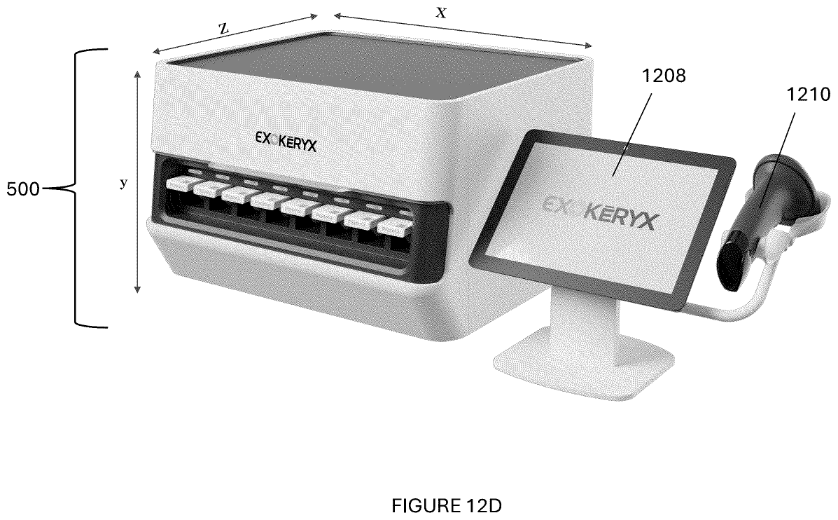

FIGS. 12A-D show the outer assembly components and air vent flow. In accordance with the preferred embodiment of the present invention, the side plates 524 are connected to a door 1212. A door switch 1216 controls a ball detent 1214 that prevents opening of the door 1212 when the door 1212 is closed. FIG. 12C shows the movement of airflow through the system. In accordance with the preferred embodiment of the present invention, air is pulled into the system via a fan. This air is used in concert with the Peltier coolers 800 to create a temperature-controlled environment. The air is then cycled out of the system 500 to the atmosphere through vents. FIG. 12D shows the outer components of the present invention. In accordance with the preferred embodiment of the present invention, the system 500 may comprise an outer shell with entry points for a plurality of cartridges. The entry points may be associated with an LED light, indicating whether or not a cartridge is contained within the associated slot. The system may comprise other components, including a barcode scanner 1210 and a tablet 1208. The barcode scanner 1210 may be configured to scan barcodes located on each cartridge for identification purposes. The tablet 1208 may be configured to allow a user to navigate the method steps via the GUI.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for semiconductor-based isolation of extracellular vesicles, the system comprising:
a cartridge device comprising:
an x-axis system;
a z-axis system;
at least one lift axis system;
a plurality of cartridge bays;
a door system;
at least one auxiliary device;
a plurality of stepper motors;
firmware configured to process and record information and create step counters for at least one of said plurality of stepper motors;
a proportional-integral-derivative (PID) controller in communication with said firmware, wherein said PID controller provides pulse-width modulation (PWM) of a thermoelectric cooler (TEC) device to maintain temperature control; and
a computer system in communication with said cartridge device, said computer system being configured to house a graphical user interface (GUI) software application configured to allow a user to choose a method for driving hardware interactions via text-based recipe files.

2. The system of claim 1, wherein said x-axis system comprises a plurality of subsystems including a pump and pressure subsystem.

3. The system of claim 1, wherein said z-axis system comprises a pipette tip interface, a tip eject, and tip-present sensor subsystem.

4. The system of claim 1, wherein said at least one lift axis system comprises a plurality of heatsinks, a plurality of pogo pin connections, and a pinch valve subsystem.

5. The system of claim 1, wherein said plurality of cartridge bays comprise a plurality of partitions, a plurality of cartridge receivers, and a plurality of light-emitting diode (LED) indicators.

6. The system of claim 1, wherein said computer system further comprises an application programming interface (API) server configured to receive representational state transfer (REST) requests and translate said REST requests into low-level firmware protocol messages sent to said firmware.

7. The system of claim 1, wherein said firmware is in communication with said computer system via two software protocols comprising command structures.

8. A method for controlling a motor system configured to isolate extracellular vesicles, the method comprising:
running a motor control algorithm via a GUI on a computer system in
communication with a cartridge device, said motor control algorithm causing a firmware having an application framework to:
process and record motor movement speed and step number via a firmware for at least one motor;
transmit, via said firmware, one-time setup parameters to a plurality of peripherals;
establish real-time task expiry time for each motor based on a designated speed;
create, via said firmware, at least one step counter for at least one motor and set a state of said at least one motor to running as part of a real-time event-handling protocol;
check for service updates of said at least one motor; and
running a temperature control timing algorithm to provide constant temperature in
a fluid integrated circuit (IC) chip via a PID controller, said temperature control timing algorithm causing said firmware to:
receive a temperature set point request;
process and record said temperature set point request;
send one-time setup parameters to various peripherals;
set up real-time task expiry time for each TEC based on indicated settings;
set up a recurring timer to send a message to process TEC controller;
check message queue via a main thread; and
upon schedule, service a TEC controller by running a current measured temperature through a dedicated PID controller routine to be sent again at a same interval defined by said recurring timer.

9. The method of claim 8, wherein said firmware translates a pump flow rate requirement into a stepping frequency that is used to drive a motor attached to a pump.

10. The method of claim 8, wherein a motor controlling mechanism is implemented using said framework's timer of said firmware's application and a real-time event system.

11. The method of claim 8, wherein a processor is allowed to sleep once all TECs are serviced.

12. The method of claim 8, wherein said GUI is a user-facing software application configured to allow a user to choose a method of driving hardware interactions taken by an instrument in communication with said GUI.

13. The method of claim 8, wherein the method is specified via text-based recipe files that use domain-specific language.

14. The method of claim 8, wherein said method is encrypted.

15. A system for semiconductor-based isolation of extracellular vesicles, the system comprising:
a cartridge device comprising:
an x-axis system comprising a plurality of subsystems including a pump and pressure subsystem;
a z-axis system comprising a pipette tip interface, a tip eject, and tip present sensor subsystem;
at least one lift axis system comprising a plurality of heatsinks, a plurality of pogo pin connections, and a pinch valve subsystem;
a plurality of cartridge bays, each of said cartridge bay comprising a plurality of partitions, a plurality of cartridge receivers, and a plurality of LED indicators;
a door system;
at least one auxiliary device;
a plurality of stepper motors;
a plurality of assembly components comprising:
a pipette gantry head,
a pogo pin lifter assembly,
a Peltier lifter,
a pinch valve filter,
a cartridge receiver,
a back plate, and
at least one side plate;
firmware configured to process and record information and create step counters for at least one of said plurality of stepper motors;
a PID controller in communication with said firmware, wherein said PID controller provides pulse-width modulation of a TEC device to maintain temperature control; and
a computer system in communication with said cartridge device, said computer system configured to house a GUI software application configured to allow a user to choose a method to drive hardware interactions via text-based recipe files.

16. The system of claim 15, wherein said pipette gantry head provides automated pipetting of a sample and reagents and comprises a frame, a main cross member, a pipette tip carrier, an eight-channel pump, and a pipette tip holder.

17. The system of claim 15, wherein said pogo pin lifter carries pin components for electrical interface to cartridge and comprises a plurality of pogo pin blocks.

18. The system of claim 15, wherein said Peltier lifter carries TECs, heatsinks, and ducting and comprises a plurality of Peltier coolers.

19. The system of claim 15, wherein said pinch valve lifter carries pinch valves and comprises a pinch valve pin cross member, a fixed plate, a cam follower, and a pinch valve bracket comprising a spring-loaded rubber piston for sealing channels under a cartridge to selectively allow fluid flow.

20. The system of claim 19, wherein each of said plurality of stepper motors enables said pressure subsystem to both draw in and expel said fluid.

21. The system of claim 15, wherein said cartridge receiver provides rails to slide a plurality of cartridges into said system and comprises a ball plunger and a cartridge switch system configured to enable detection of cartridge with haptic feedback for a user.
